(19) United States
(12) Patent Application Publication
(10) Pub. No.: US 2010/0030760 A1
(43) Pub. Date: Feb. 4, 2010

(54) DATA INPUT APPARATUS AND DATA INPUT METHOD

(75) Inventor: Kensuke MASUGATA, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi (JP)

(21) Appl. No.: 12/535,209

(22) Filed: Aug. 4, 2009

(30) Foreign Application Priority Data
Aug. 4, 2008 (JP) 2008-201214

(51) Int. Cl. G06F 7/10; G06F 17/30

(52) U.S. Cl. 707/4; 707/E17.109; 707/7; 707/5; 707/E17.071

(57) ABSTRACT

When an input acknowledging unit acknowledges the input of pre-conversion data from the user via the user interface, an ordinary conversion processing unit that uses a dictionary database displays a candidate of converted data. When the input of search data is acknowledged from the user via the user interface, a search conversion processing unit that uses a search service etc. displays search result data or the candidate of converted data.

### BACKGROUND OF THE INVENTION

1. Field of the Invention

The present invention relates to a technology of inputting data and, more particularly, to a data input apparatus, data input method, and data input program for converting data acknowledged from a user into other data and inputting the data.

2. Description of the Related Art

Programs for converting readings input by a user into a kanji character and inputting a Japanese character string accordingly are widely used (see, for example, patent document No. 1).

[patent document No. 1] JP 2004-139402

In the conventional conversion (e.g., input by kana-to-kanji conversion), input is not possible if the user is ignorant of the readings of the desired kanji. Accessing a search site on the Internet will allow the user to search for a desired character string in a variety of manners. However, this requires complicated, extra tasks of starting a separate application (e.g., web browser) to use a search service and display a search result accordingly. and then copying and pasting the result from the web browser to the target application. In this background, a more convenient technology for inputting data is called for.

### SUMMARY OF THE INVENTION

The present invention addresses the drawback and a purpose thereof is to provide a technology capable of improving the convenience of data input.

One embodiment of the present invention relates to a data input apparatus. The data input apparatus comprises: an input acknowledging unit configured to acknowledge data from a user; an ordinary conversion processing unit configured to output data generated by converting the input data acknowledged from the user; a search conversion processing unit configured to output data generated from a result of search conducted based on the input data acknowledged from the user, wherein the ordinary conversion processing unit comprises: a candidate extracting unit configured to extract a candidate of converted data by referring to a dictionary database by using the input data; and a candidate displaying unit configured to display the candidate of converted data and acknowledge the selection of converted data from the user, wherein the search conversion processing unit comprises: a communication unit configured to issue a search request to a search service by using the input data so as to obtain search result data; and a search conversion displaying unit configured to display the search result data or a candidate of converted data obtained by processing the search result data in accordance with a predetermined condition.

The search conversion displaying unit may display a browser for displaying a search data input screen or search result data, and the input acknowledging unit may acknowledge at least one item of data arbitrarily designated by the user from the search result displayed in the browser.

The apparatus may further comprise: a search conversion order determining unit configured to determine the order of arranging the search result data in accordance with the relevance to the context occurring before and after a position where data is output, wherein the search conversion displaying unit may display the search result data in accordance with the order of arrangement determined by the search conversion order determining unit.

The communication unit may use path information to issue a directory search request to a directory management service and obtain lower path information as search result data, the search conversion displaying unit may display the lower path information in a directory tree screen, and the input acknowledging unit may acknowledge path information arbitrarily designated by the user from the path information in the directory tree screen.

The apparatus may further comprise: a search conversion candidate extracting unit configured to acknowledge search result data from the communication unit and extract a candidate of converted data from the search result data in accordance with a predetermined condition; and a search conversion order determining unit configured to determine, when a plurality of candidates of converted data are extracted by the search conversion candidate extracting unit, the order of displaying the plurality of candidates of converted data in accordance with a predetermined condition, wherein the search conversion displaying unit may display the candidates of converted data in accordance with the display order determined by the search conversion order displaying unit and acknowledge the selection of converted data from the user.

The search conversion candidate extracting unit may extract candidates of converted data from search result data in accordance with the relevance to the context occurring before and after a position where data is output, and the search conversion order determining unit may determine the order of arranging the candidates of converted data in accordance with the relevance to the context occurring before and after a position where data is output.

The communication unit may issue a request for translation to a translation service so as to obtain a translation result, and the search conversion candidate extracting unit may extract a candidate of converted data from the translation result in accordance with the relevance to the context occurring before and after a position where data is output.

The communication unit may provide a search service with a request to search for a plurality of synonym data items so as to obtain search result data comprising the synonym data items, and the search conversion candidate extracting unit may extract, as candidates of converted data from, the synonym data items from the search result data, and the search conversion order determining unit may determine the order of arranging the candidates of converted data in accordance with the number of hits of each synonym data item in the search result data.

The communication unit may provide a search service with a request to search for at least one data item related to a mathematical expression so as to obtain search result data comprising the data related to a mathematical expression, the search conversion candidate extracting unit may extract, as a candidate for converted data, the data related to a mathematical expression from the search result data, and the search conversion order determining unit may determine the order of arranging the candidates of converted data in accordance with the relevance to the context occurring before and after a position where data is output.

Another embodiment of the present invention relates to a data input method. The data input method comprises: acknowledging data from a user; i) outputting data generated by converting the input data acknowledged from the user; ii) outputting data generated from a result of search conducted based on the input data acknowledged from the user, wherein step i) comprises: extracting a candidate of converted data by referring to a dictionary database by using the input data; and displaying the candidate of converted data and acknowledging the selection of converted data from the user, and step ii) comprises: issuing a search request to a search service by using the input data so as to obtain search result data; and displaying the search result data or a candidate of converted data obtained by processing the search result data in accordance with a predetermined condition.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a functional block diagram showing the structure of a data input apparatus according to the embodiment;

FIG. 2 is a functional block diagram showing the detailed structure of the ordinary conversion processing unit of the data input apparatus of FIG. 1;

FIG. 3 is a functional block diagram showing the detailed structure of the search conversion processing unit of the data input apparatus of FIG. 1;

FIG. 4 shows a user interface for inputting a character string using the data input apparatus;

FIG. 5 shows a user interface for a step next to that of FIG. 4;

FIG. 6 shows a user interface for a step next to that of FIG. 5;

FIG. 7 shows a user interface for inputting a character string using the data input apparatus;

FIG. 8 shows a user interface for a step next to that of FIG. 7;

FIG. 9 shows a user interface for inputting a character string using the data input apparatus;

FIG. 10 shows a user interface for inputting a character string using the data input apparatus;

FIG. 11 shows a user interface for inputting a character string using the data input apparatus; and

FIG. 12 shows a user interface for inputting a character string using the data input apparatus.

### DETAILED DESCRIPTION OF THE INVENTION

The invention will now be described by reference to the preferred embodiments. This does not intend to limit the scope of the present invention, but to exemplify the invention. In this embodiment, there is proposed a technology adapted for a data input apparatus for converting user input data into converted data and outputting the converted data, and providing a search conversion function for converting a search result obtained by using user input data as search data into converted data by referring to the user designation and for outputting the result, in addition to an ordinary conversion function converting user input data (pre-conversion data) into converted data,

Conventionally, it has been difficult in kana reading-to-kanji conversion to output a desired kanji if the user is ignorant of the readings of the desired kanji. The technology proposed in the embodiment allows selecting a desired kanji from a search result and outputting the kanji even when the user is ignorant of the readings of the desired kanji, by inputting a keyword and performing a search conversion. This will greatly improve the convenience of data input.

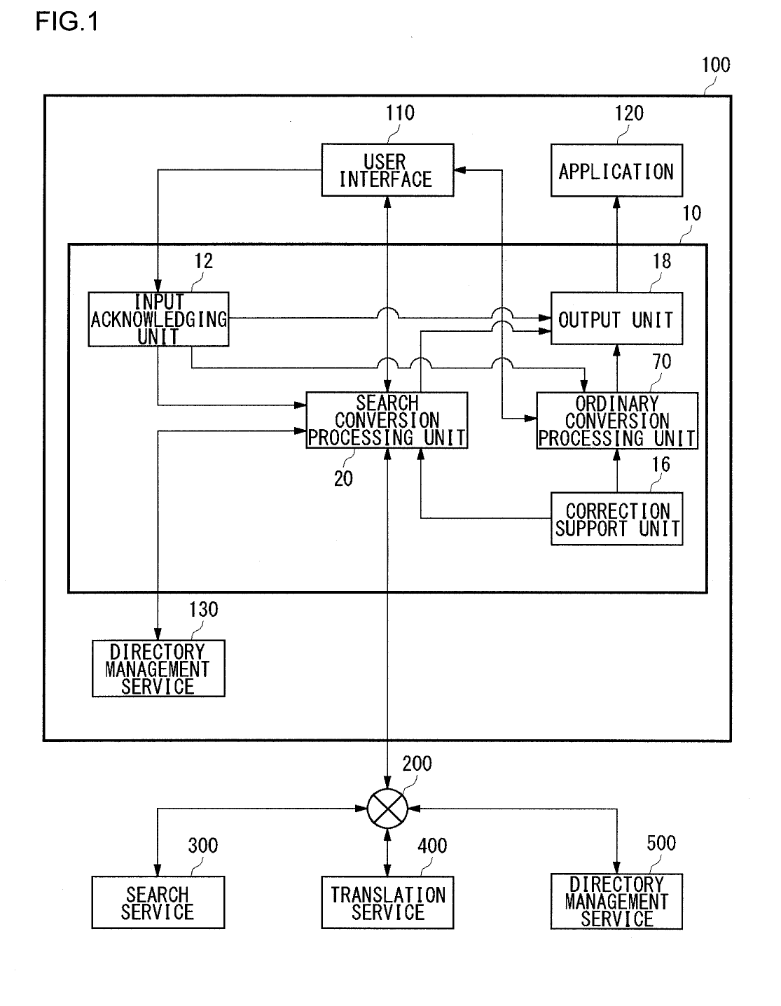

FIG. 1 is a functional block diagram showing the structure of a data input apparatus 10 according to the embodiment. The data input apparatus 10 supports data input by the user in an application 120. In other words, for data input in the application 120, the user inputs data via a user interface 110, and candidates of converted data are invoked from the input data, and the data designated by the user from the candidates is output to the application 120 via an output unit 18.

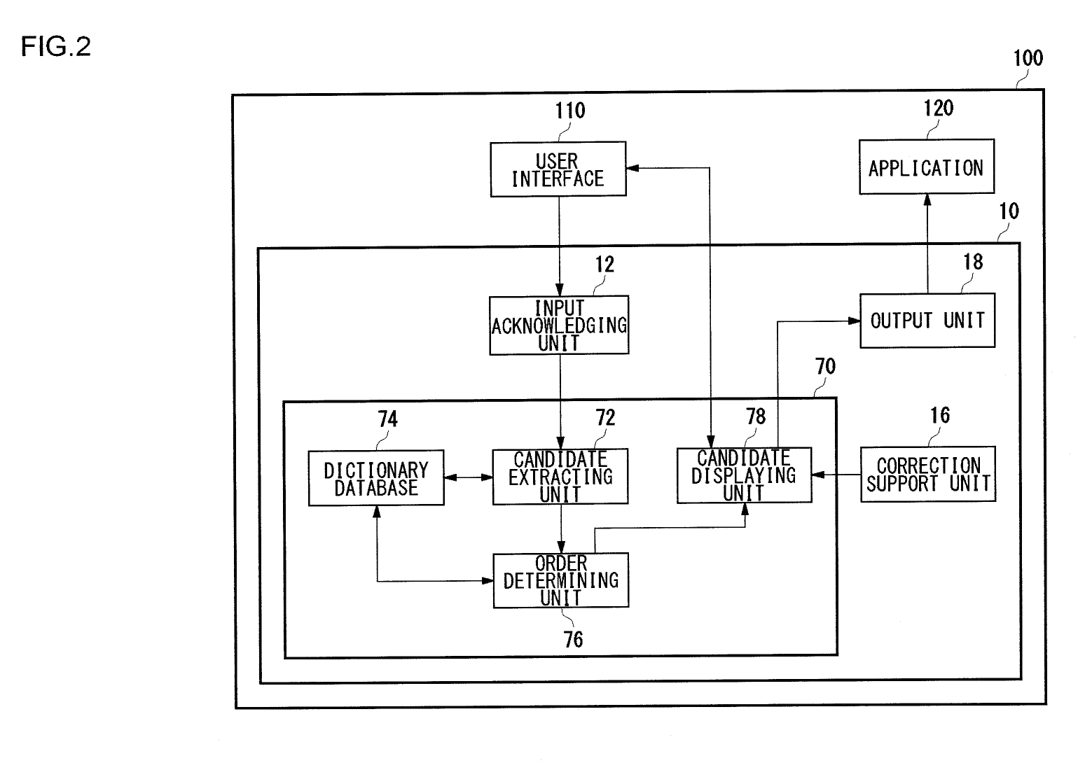

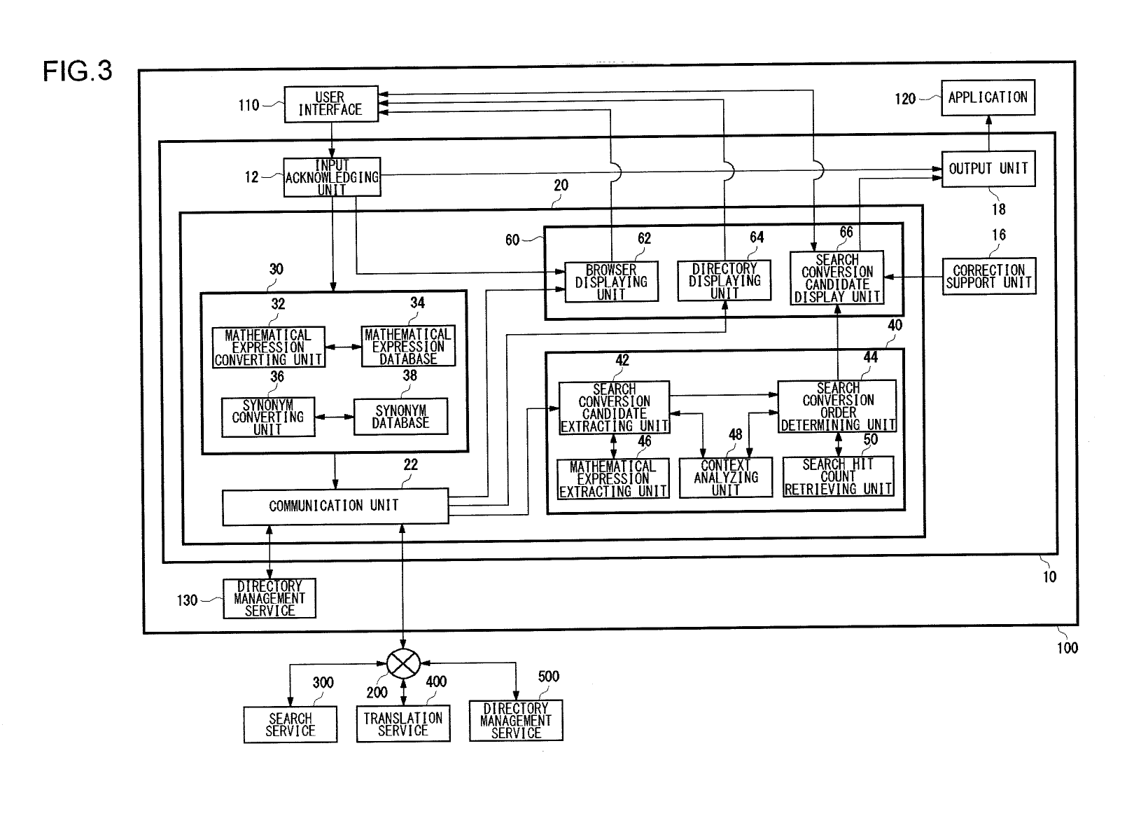

The data input apparatus 10 is provided with an input acknowledging unit 12, a correction support unit 16, an output unit 18, a search conversion processing unit 20, an ordinary conversion processing unit 70. The configuration is implemented, in hardware components, by any CPU of a computer, a memory, and in software by a program or the like loaded into the memory. FIG. 1 depicts functional blocks implemented by the cooperation of hardware and software. Therefore, it will be obvious to those skilled in the art that the functional blocks may be implemented in a variety of manners by hardware only, software only, or a combination of thereof. The same is true of FIGS. 2 and 3 explained later.

The input acknowledging unit 12 acknowledges data from the user via the user interface 110 and requests the ordinary conversion processing unit 70 or the search conversion processing unit 20 to process the data in accordance with the user request. In other words, if the user requests an ordinary conversion process, the input acknowledging unit 12 requests the ordinary conversion processing unit 70 to process the input data as pre-conversion data. If the user requests a search conversion process, the input acknowledging unit 12 requests the search conversion processing unit 20 to process the input data as search data or pre-translation data.

The correction support unit 16 supports data correction in the ordinary conversion processing unit 70 and the search conversion processing unit 20. For example, if it is supposed that the user inputs wrong pre-conversion data, the error is communicated to the user. The output unit 18 outputs the converted data selected by the user via the user interface 110 to the application 120. Details of the search conversion processing unit 20 and the ordinary conversion processing unit 70 will be described later.

FIG. 2 is a functional block diagram showing the detailed structure of the ordinary conversion processing unit 70. The ordinary conversion processing unit 70 performs an ordinary conversion process including kana reading-to-kanji conversion. Normally, an ordinary conversion process uses the dictionary function provided in the data input apparatus 10 to convert input data. The ordinary conversion processing unit 70 is provided with a candidate extracting unit 72, a dictionary database 74, an order determining unit 76, and a candidate displaying unit 78.

The dictionary database 74 stores pre-conversion data and converted data in association with each other. For example, the dictionary database 74 used to output a kanji to the application 120 stores the readings of kanjis as pre-conversion data and stores kanjis as converted data.

The candidate extracting unit 72 refers to the dictionary database 74 and extracts a candidate of converted data corresponding to pre-conversion data acknowledged by the input acknowledging unit 12. When a plurality of candidates of converted data are extracted by the candidate extracting unit 72, the order determining unit 76 determines the order of displaying the plurality of candidates of converted data in accordance with a predetermined condition. The predetermined condition may order the candidates according to the history of conversion by the user or order the candidates using a context analyzing unit 48 described later. The candidate displaying unit 78 displays the candidates of converted data according to the display order determined by the order determining unit 76 and acknowledges the selection of converted data from the user.

FIG. 3 is a functional block diagram showing the detailed structure of the search conversion processing unit 20. The search conversion processing unit 20 performs a search conversion process using a search service or a translation service. The search conversion process mainly uses a data provider service outside the data input apparatus 10 to convert input data. The search conversion processing unit 20 is provided with a search data converting unit 30, a communication unit 22, a search result data converting unit 40, and a search conversion displaying unit 60.

The search data converting unit 30 refers to search data acknowledged by the input acknowledging unit 12 and retrieves other search data based on the acknowledged data. For example, the search data converting unit 30 may include a mathematical expression converting unit 32 and a mathematical expression database 34. In this case, the mathematical expression database 34 stores keywords related to mathematical expressions in association with mathematical expression data. If “solution of a quadratic equation” is acknowledged as search data, the mathematical expression converting unit 32 refers to the mathematical expression database 34 and retrieves mathematical expression data for a quadratic equation solution formula.

In an alternative example, the search data converting unit 30 may include a synonym converting unit 36 and a synonym database 38. In this case, the synonym database 38 stores, for example, synonym data for synonyms such as “INN-TA-FEE-SU” (interface), “INN-TAA-FEE-SU” (interface), and “INN-TAA-FEI-SU” (interface), associating the synonyms with each other. If “INN-TA-FEI-SU” is acknowledged as search data, the synonym converting unit 36 refers to the synonym database 38 and retrieves associated synonym data.

The communication unit 22 acknowledges search data or pre-translation data. The communication unit 22 issues a search request or a request for translation to a directory management service 130 in a local machine 100, a search service 300, a translation service 400, or a directory management service 500 located on a communication network 200 and receives search result data or translation result data. While the figure shows a general setup where the search service 300 and the translation 400 are located on the communication network, the services may be located in the local machine.

The search result data converting unit 40 acknowledges search result data or translation result data output from the communication unit 22, extracts candidates of converted data in accordance with a predetermined condition, and determines the order of displaying the candidates of converted data in accordance with a predetermined condition. The search result data converting unit 40 includes a search conversion candidate extracting unit 42, a search conversion order determining unit 44, a mathematical expression extracting unit 46, a context analyzing unit 48, and a search hit count retrieving unit 50.

The search conversion candidate extracting unit 42 extracts candidates of converted data from search result data or translation result data in accordance with a predetermined condition. Generally, the search result data itself includes a variety of data (e.g., character strings) other than the candidates of converted data. The search conversion candidate extracting unit 42 retrieves candidates of converted data from the search result data by using the context analyzing unit 48 described later. When a plurality of candidates of converted data are extracted by the search conversion candidate extracting unit 42, the search conversion order determining unit 44 determines the order of displaying the plurality of candidates of converted data. The mathematical expression extracting unit 46 extracts a mathematical expression from the search result data. In this case, the unit 46 may refer to the mathematical expression database 34 to extract a mathematical expression from the search result data. The search hit retrieving unit 50 retrieves the number of search hits from the search result data.

The context analyzing unit 48 determines the level of relevance to the context occurring before and after a position where data is output. The context analyzing unit 48 may communicate with the application 120 to which the data is output and determine the character string to be output by retrieving the character strings occurring before and after a position where data is output. For example, the unit 48 may subject the character strings retrieved from the application 120 and occurring before and after the output of data to morphological analysis so as to determine the part of speech of the character strings. Alternatively, the unit 48 may narrow down the list of relevant character strings, based on the modification structure such as the subject-predicate relationship or the modifier-modificand relationship.

The search conversion displaying unit 60 displays the search result data received from the communication unit 22 or the converted data received from the search result data converting unit 40. The search conversion displaying unit 60 includes a browser displaying unit 62, a directory displaying unit 64, and a search conversion candidate displaying unit 66.

The browser displaying unit 62 displays a browser for acknowledging search data from the user and displays search result data received from the communication unit 22 in the browser. The directory displaying unit 64 displays the search result data received from the communication unit 22 in a directory tree screen. The search conversion candidate displaying unit 66 displays the candidates of converted data in accordance with the display order determined by the search conversion order determining unit 44 and acknowledges the selection of converted data.

A description will be given of how the functional blocks described above are coordinated to achieve the improvement in the convenience of data input, by illustrating specific user interfaces.

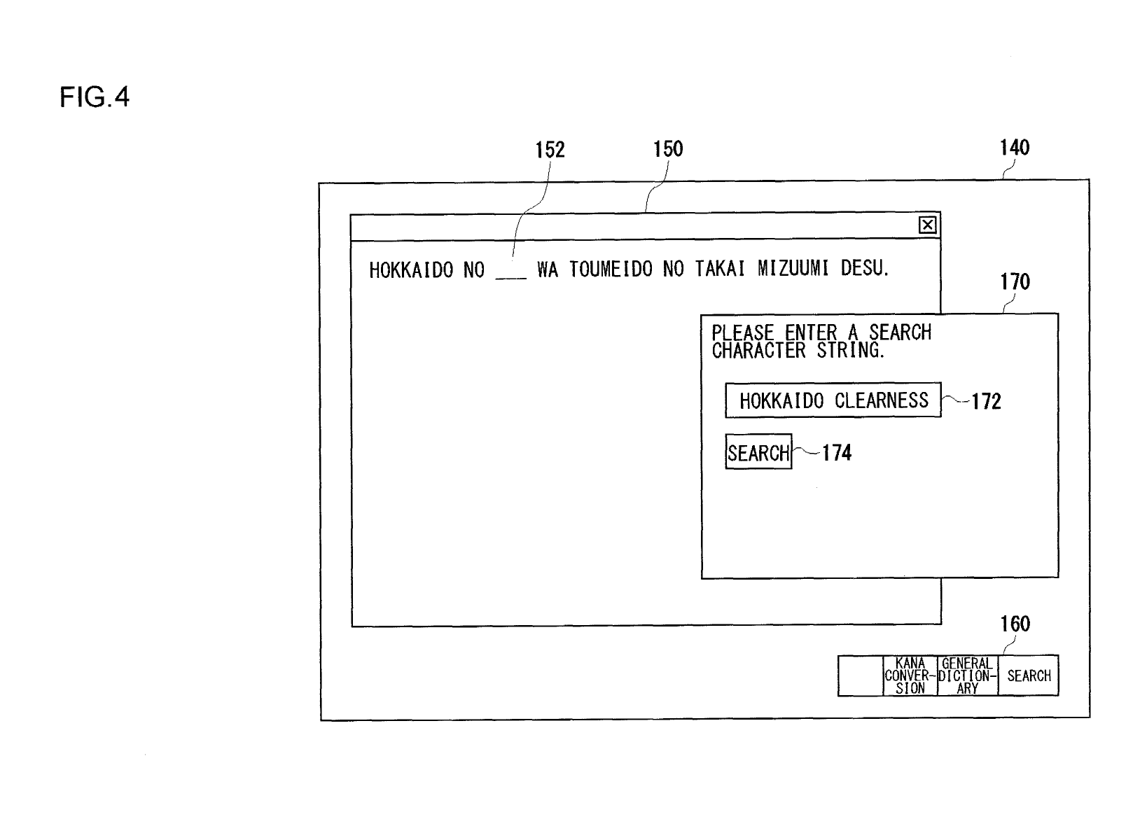

FIG. 4 shows a user interface for inputting a character string using the data input apparatus 10. Referring to the figure, the user is drafting a sentence using an application 150 displayed on a display 140. The user desires to enter the name of an appropriate lake at a data output position 152 between the character string “Hokkaido no (Hokkaido's)” and the character string “wa toumeido no takai mizuumi desu (is a clear lake)” but cannot recall the readings of the lake. The figure shows that the user has started a search apparatus 160 of the data input apparatus and has caused a browser 170 to be displayed. The user has entered search data “Hokkaido Clearness” in a text field 172.

In this example, when the search apparatus 160 of the data input apparatus is started, the input acknowledging unit 12 acknowledges a search request and the browser displaying unit 62 starts the browser 170. When a character string is entered in the text field 172 and a search execution button 174 is pressed, the input acknowledging unit 12 acknowledges the character string as search data. The communication unit 22 issues a search request to a search service based on the search data and obtains the search result data. The browser displaying unit 62 displays the search result data in the browser 170. The user can designate any character string from the character string(s) displayed in the browser 170.

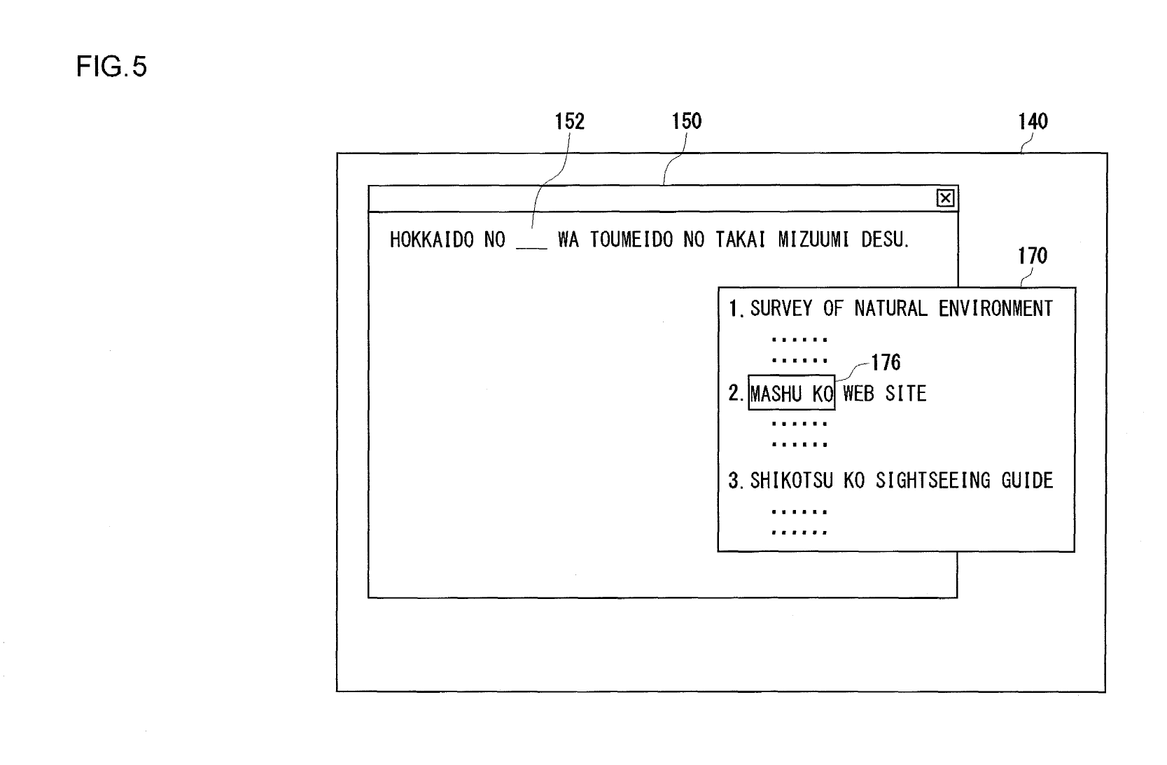

FIG. 5 shows a user interface for a step next to that of FIG. 4. The figure shows that the browser displaying unit 62 displays the search result data in the browser 170 and the user designates an arbitrary character string “Mashu ko”. In this state, the user may designate any arbitrary character string.

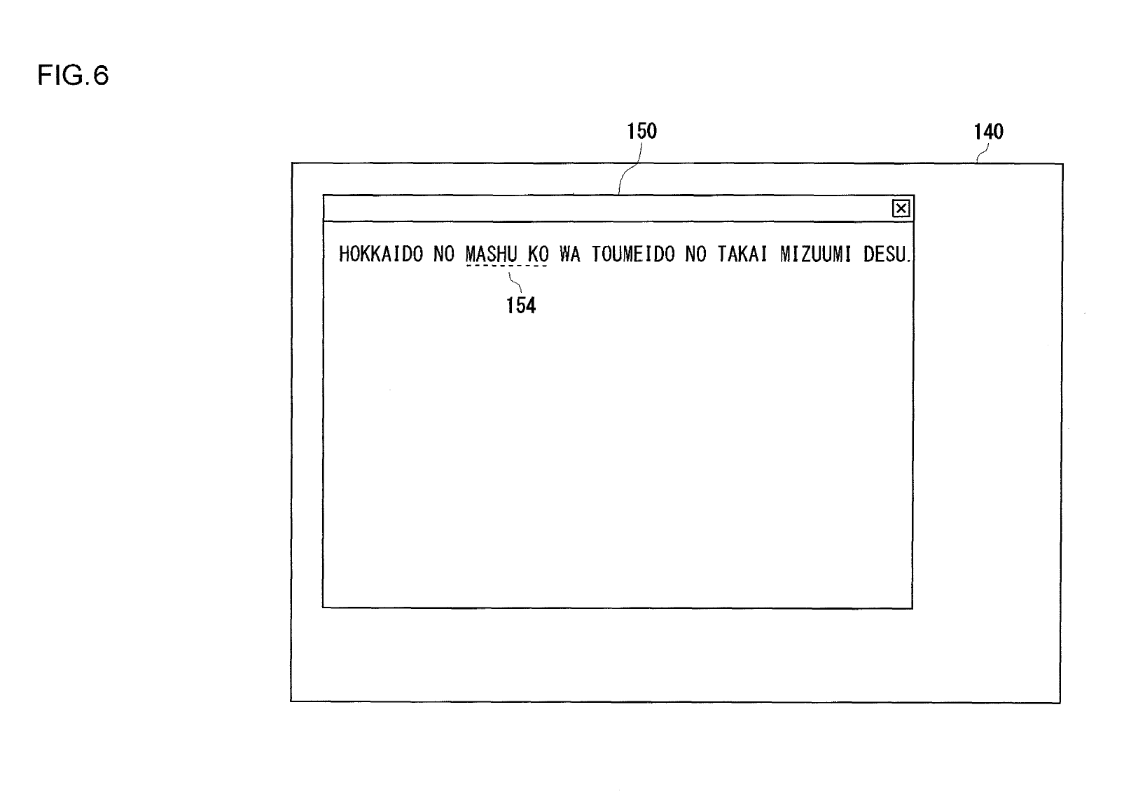

FIG. 6 shows a user interface for a step next to that of FIG. 5. The figure shows that a character string “Mashu ko” 154 designated by the user is displayed as a unconfirmed character string. The character string 154 may be displayed as an unconfirmed character string so that the convenience of data input is further improved with the use of the correction support function. Alternatively, the data input apparatus 10 may import the character string 154 as search data for a second time and perform a search conversion process. Still alternatively, the string 154 may be output as a confirmed character string, bypassing the unconfirmed character string state. The variations above apply to the other embodiments as well.

The browser displaying unit 62 may display only those data that are extracted from the search result data by the search conversion candidate extracting unit 42 using the context analyzing unit 48 and that are more relevant to the context occurring before and after the data output position 152. The browser displaying unit 48 may display the data in the order of arranging the search result data that is determined by the search conversion order determining unit 44 using the context analyzing unit 48 and that is more relevant to the context before and after the data output position 152. Still alternatively, the browser displaying unit 62 may display the data extracted by the search conversion candidate extracting unit 42 in the order of arrangement determined by the search conversion order determining unit 44.

A description will be given of a specific example in which the context analyzing unit 48 analyzes the data in the case of FIG. 4. In this case, a modifier “Hokkaido no” precedes the data output position and a particle “wa” follows the data output position so that the context analyzing unit 48 can determine that a noun that serves as a subject fits the data output position. Since the predicate is “mizuumi desu (is a lake)”, the context analyzing unit 48 can determine that the name of a lake (e.g. Lake XX) fits the place. Therefore, in the case of FIG. 5, items including character strings “Mashu ko” and “Shikotsu ko” are displayed toward the top of the list.

Such a technology helps the user to identify and output a desired kanji even when the user is ignorant of the readings of the desired kanji. The inventive approach also makes available the correction support function which would not be available if the web browser is started separately to make a search and a copy-and-paste operation. Thus, the convenience of data input is improved.

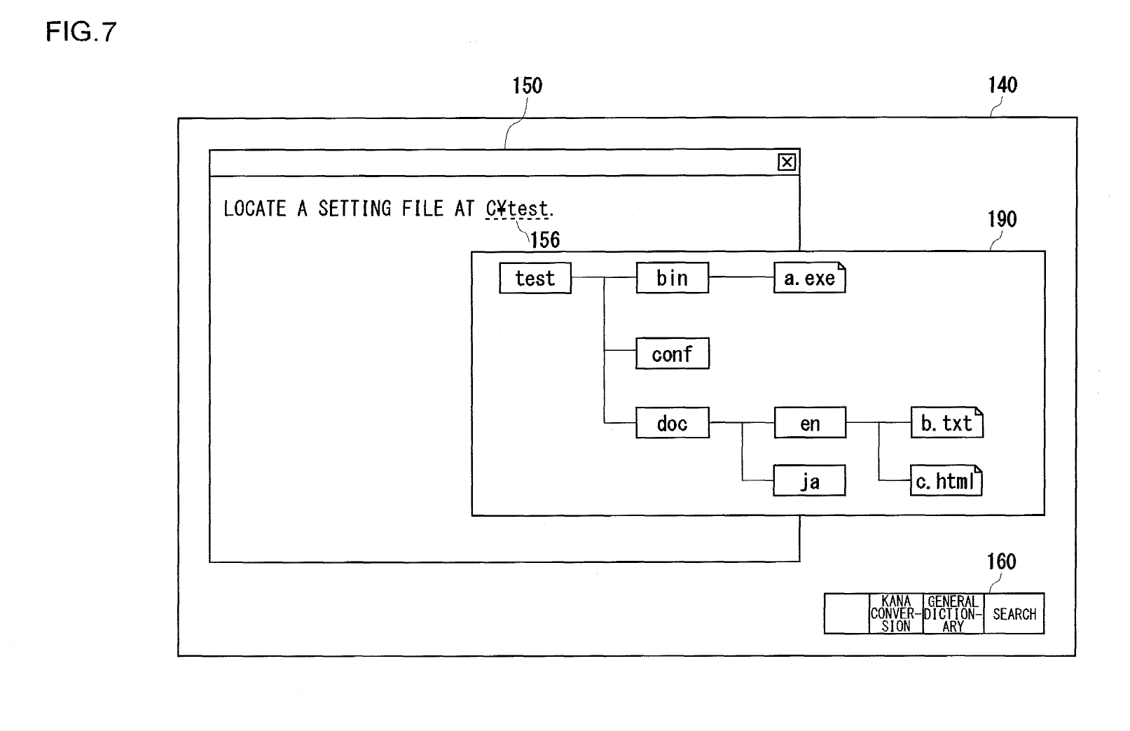

FIG. 7 also shows a user interface for inputting a character string using the data input apparatus 10. The figure shows that the search apparatus 160 of the data input apparatus 10 is started when the user drafting a sentence using the application 150 has input a part of a desired path name character string as a character string 156. A directory tree screen 190 displays directories and files lower in the hierarchy than the path indicated by the path name character string input by the user.

When a part of the path name character string is input by the user and the search apparatus 16 of the data input apparatus is started, the input acknowledging unit 12 acknowledges the path name character string as search data. The communication unit 22 issues a request for search to the directory management service 130 or the directory management service 500, using the search data as a search key, so as to obtain a search result. The directory displaying unit 64 displays the search result, i.e., lower path information, in the directory tree screen 190. In this case, the directory management service is not limited to the service for managing directories or files. For example, a directory server may be searched for uniform resource identifiers (URSs) located on the communication network, by using the lightweight directory access protocol (LDAP) so that the search result is displayed.

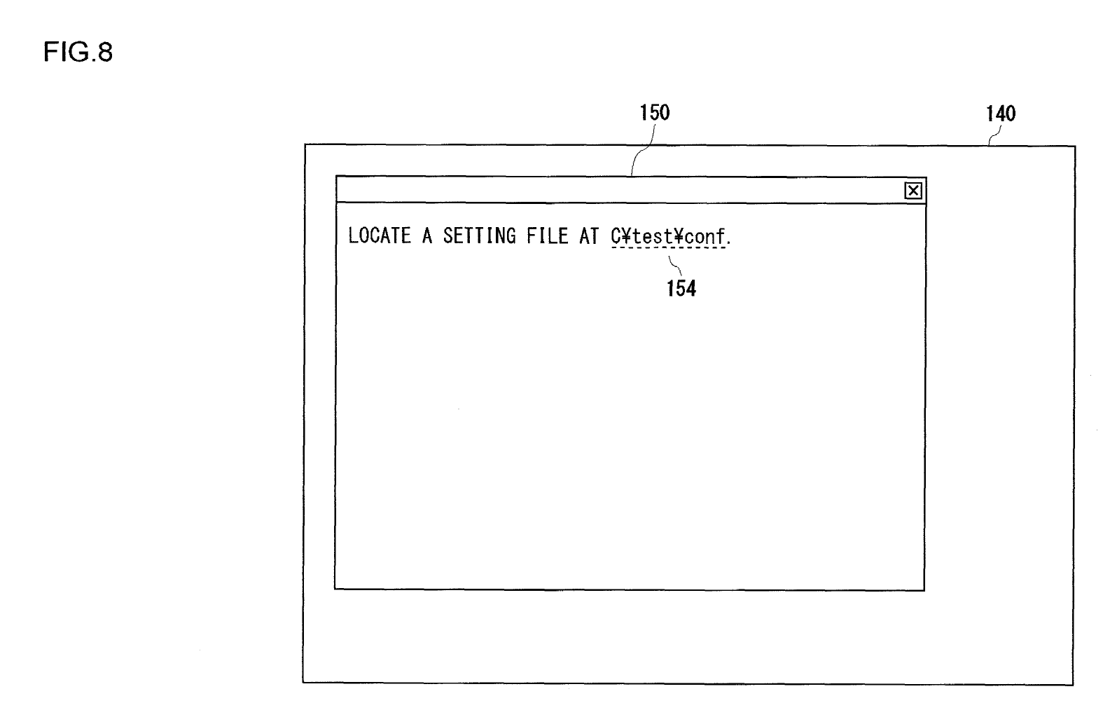

FIG. 8 shows a user interface for a step next to that of FIG. 7. The figure shows that character string 154 “c¥test¥conf” is output to the application 150 as a result of the user designating ¥test¥conf in the directory tree screen 190.

The inventive technology allows the user to output a desired path name character string with less of a hassle, by inputting a part of the desired path name character string. Moreover, errors in the input such as misspelling are eliminated. Thereby, the convenience of data input is improved.

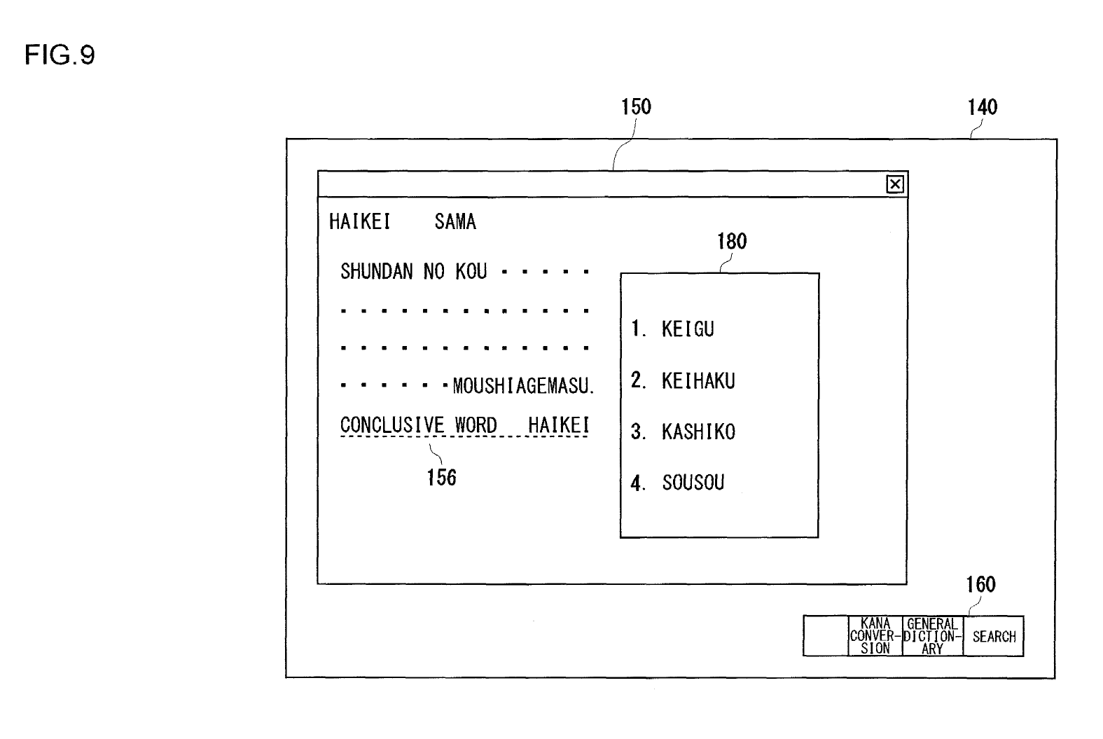

FIG. 9 shows another user interface for inputting a character string using the data input apparatus 10. The figure shows that the user is drafting a sentence headed by the word “Haikei”, using the application 150 but the user is ignorant of the readings of the conclusive word. The figure shows that the user has started the search apparatus 160 of the data input apparatus after inputting the character string 156 “Conclusive word Haikei” as search data. Candidates 180 of converted data resulting from a search conversion process conducted based on the search data are displayed. In this state, the user is allowed to select a desired character string from the candidates 180 of converted data.

In this example, when the user starts the search apparatus 160 after inputting the character string related to the desired kanji, the input acknowledging unit 12 acknowledges the character string as search data. The communication unit 22 issues a search request to a search service based on the search data and obtains the search result data. The search conversion candidate extracting unit 42 uses the context analyzing unit 48 to extract, as candidates for converted data, search result data more relevant to the context occurring before and after a position where data is output. The search conversion order determining unit 44 uses the context analyzing unit 48 to determine the order of arranging the candidates for converted data more relevant to the context occurring before and after a position where data is output. The search conversion candidate displaying unit 66 displays the candidates 180 of converted data according to the display order determined by the search conversion order determining unit 44 and acknowledges the selection of converted data from the user. The technology of displaying the candidates 180 of converted data is non-limiting. For example, the window for displaying candidates of converted data in an ordinary conversion process may be used. Alternatively, a standard window provided by the operating system (OS) may be used. Still alternatively, a browser may be used. The variations above apply to the other embodiments as well.

A specific example of analysis by the context analyzing unit 48 will be described with reference to FIG. 9. In this case, the data is output at a position at the end of a sentence header by “Haikei”, the context analyzing unit 48 may determine that a character string representing a conclusive word is more relevant among the search result data. Of the conclusive words, the unit 48 may determine that the character string corresponding to the header word “Haikei” is more relevant.

The inventive technology allows the user to output a desired path name character string with less of a hassle, by inputting a character string related to the desired kanji. The inventive approach also makes available the correction support function which would not be available if the web browser is started separately to make a search and a copy-and-paste operation. Thus, the convenience of data input is improved.

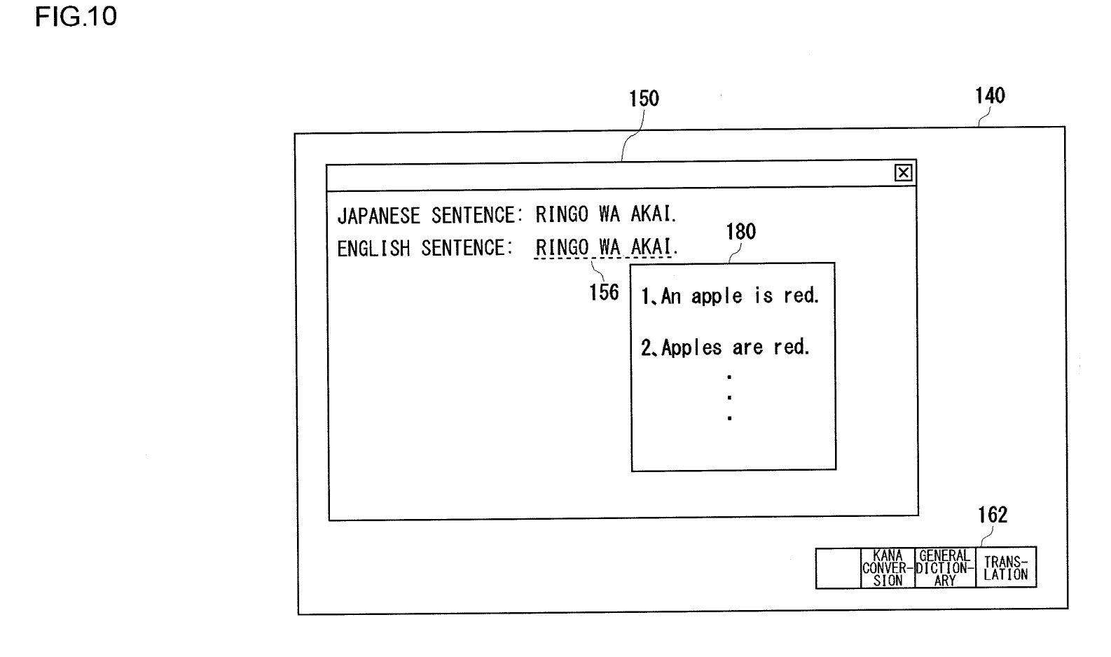

FIG. 10 shows another user interface for inputting a character string using the data input apparatus 10. The figure that the user desires to input an English sentence corresponding to a Japanese sentence meaning “Ringo wa akai (Apples are red)” but cannot. The figure shows that the user has started the translation apparatus 162 of the data input apparatus after inputting the Japanese character string 156 “Ringo wa akai (Applies are red)” as pre-translation data. Candidates 180 of converted data resulting from a translation based on the pre-translation data are displayed. In this state, the user is allowed to select a desired character string from the candidates 180 of converted data.

In this example, when the user starts the translation apparatus 162 after inputting the pre-translation data, the input acknowledging unit 12 acknowledges the pre-translation data. The communication unit 22 issues a request for translation to the translation service, using the pre-translation data as a search key, so as to obtain a translation result. The search conversion candidate extracting unit 42 uses the context analyzing unit 48 to extract, as candidates for converted data, translation result data more relevant to the context occurring before and after a position where data is output. The search conversion order determining unit 44 uses the context analyzing unit 48 to determine the order of arranging the candidates for converted data more relevant to the context occurring before and after a position where data is output. The search conversion candidate displaying unit 66 displays the candidates of converted data according to the display order determined by the search conversion order determining unit 44 and acknowledges the selection of converted data from the user.

A specific example of analysis by the context analyzing unit 48 will be described with reference to FIG. 10. In this case, the context analyzing unit 48 may determine an English sentence, including an English word “apple” corresponding to a Japanese character string “ringo” occurring before the character output position and including an English word “red” corresponding to “akai”, as being relevant.

The inventive technology allows the user to output a sentence in a desired another language with less of a hassle, by providing an input in the user's mother tongue, even when the user is ignorant of the spelling in the desired other language. Unlike simple dictionary-based word-for-word conversion, output of a natural sentence that allows for collocation is allowed. The inventive approach can also make available the correction support function which would not be available if the web browser is started separately to make a search and a copy-and-paste operation. Thus, the convenience of data input is improved.

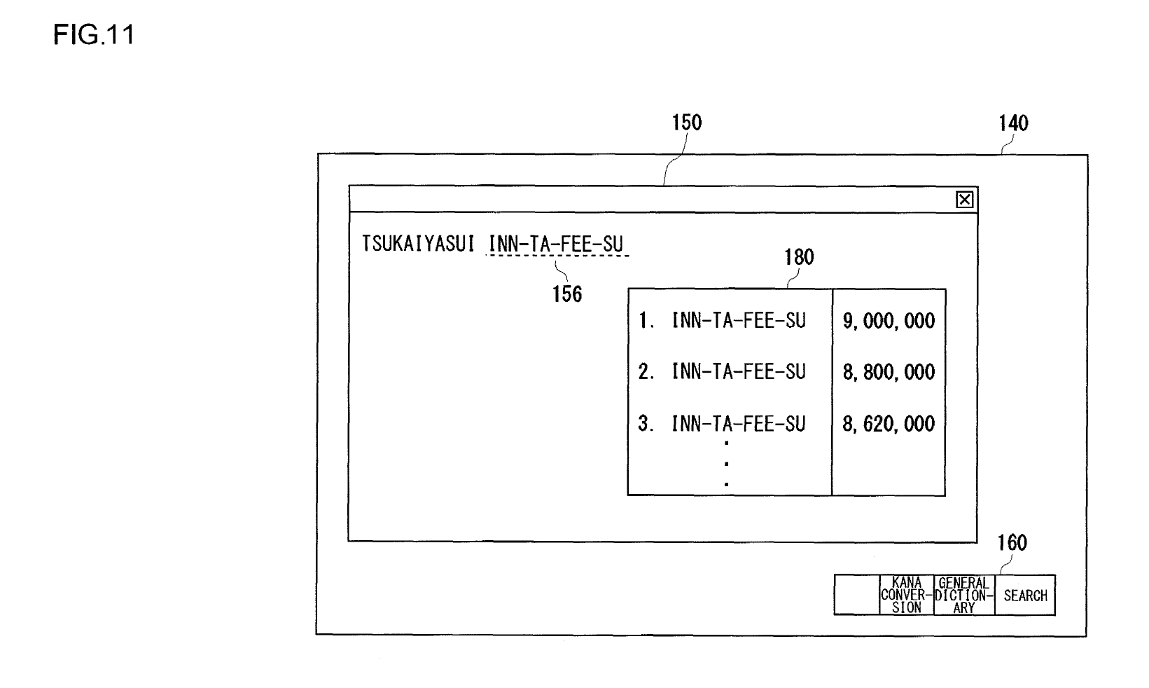

FIG. 11 shows a user interface for inputting a character string using the data input apparatus 10. The figure shows that the user desires to select the most popular term from the group of character strings “INN-TA-FEE-SU” (interface), “INN-TAA-FEE-SU” (interface), and “INN-TAA-FEI-SU” (interface) having synonyms. The figure shows that the user has started the search apparatus 160 of the data input apparatus after inputting the a character string 156 “INN-TA-FEI-SU” having synonyms as search data. The search data and the synonym data associated with the search data, which result from the search conversion process, are displayed as candidates 180 of converted data along with the number of search hits. In this state, the user may refer to the number of search hits and select the term associated with the largest number of search hits as the most popular term.

In this example, when the user starts the search apparatus 160 after inputting a character string having synonyms, the input acknowledging unit 12 acknowledges the character string as search data. The synonym converting unit 36 refers to the synonym database 38 and searches for the synonym data associated with the search data. The communication unit 22 issues a search request to a search service based on the search data and the synonym and obtains the search result data. The search conversion candidate extracting unit 42 extracts, as candidates of converted data, the search data and the synonym data from the search result data. The search conversion order determining unit 44 uses the search hit count retrieving unit 50 and determines the order of arranging the candidates for converted data in accordance with the number of search hits of the search result data for the search data and the number of search hits of the search result data for the synonym data. The search conversion candidate displaying unit 66 displays the candidates of converted data according to the display order determined by the search conversion order determining unit 44 along with the number of search hits, and acknowledges the selection of converted data from the user.

The inventive technology allows the user inputting a character string having synonyms can know the number of hits of each synonym and can select a more appropriate character string. Thereby, the convenience of data input is improved.

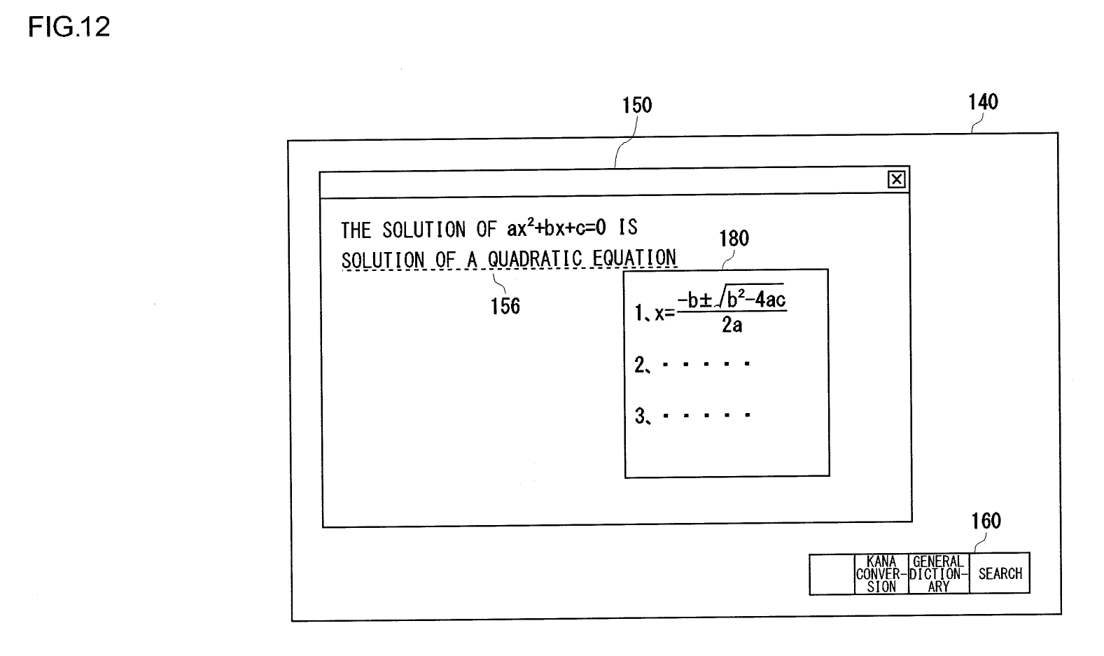

FIG. 12 shows a user interface for inputting a character string using the data input apparatus 10. The figure shows that the user starts the search apparatus 160 of the data input apparatus after inputting the character string 156 “solution of a quadratic equation” related to a desired numerical expression, and that candidates 180 of converted data including numerical expressions resulting from a search based on the search data are displayed. In this state, the use may select and output a desired numerical expression.

In this example, when the user starts the search apparatus 160 after inputting the character string related to the numerical expression, the input acknowledging unit 12 acknowledges the character string as search data. The numerical expression converting unit 32 refers to the mathematical expression database 34 and retrieves mathematical expression data associated with the search data. The communication unit 22 issues a search request to a search service based on the search data and the numerical expression data thus retrieved. The search conversion candidate extracting unit 42 uses the numerical expression extracting unit 46 to extract numerical expression data from search result data. The search conversion order determining unit 44 uses the context analyzing unit 48 to determine the order of arranging the candidates for converted data more relevant to the context occurring before and after a position where data is output. The search conversion candidate displaying unit 66 displays the candidates of converted data according to the display order determined by the search conversion order determining unit 44 and acknowledges the selection of converted data from the user.

A description will be given, with reference to FIG. 12, of a specific example in which the context analyzing unit 48 analyzes the data in the case of FIG. 4. In this case, the context analyzing unit 48 may import the character string preceding the character output position and determine that the mathematical expression including “a”, “b”, “c”, and “x” as being relevant to the context. The context analyzing unit 48 may retrieve the mathematical expression data associated with the search data from the mathematical expression database and determine that the mathematical expression similarly formatted as being relevant to the context.

TeX and mathematics markup language (MathML) are generally known as a technology to describing mathematical expressions. However, the description using these techniques is generally complex. With the technology using search conversion, the user may enter a keyword related to a mathematical expression to cause the data for the expression itself to be output. For example, the user may select and output mathematical expression data similar to the desired mathematical expression and turn the output expression into the desired mathematical expression by modifying the data. This facilitates description of a mathematical expression easier than describing an expression from the scratch using Tex or MathML. Thereby, the convenience of data input is improved.

Described above is an explanation based on an exemplary embodiment.

In the related-art data input apparatus, the volume of information in a dictionary holds a key to improvement in the precision of conversion from input data into output data, i.e., to the preparation of output data as desired by the user. Determination of output data relevant to the context may be achieved with high precision by providing elaborate context analyzing functions and syntax analyzing functions. However, improved in the precision of data conversion cannot be hoped for if the candidates of output data subject to such analysis cannot be retrieved from the dictionary.

However, the volume of information in a dictionary is limited. For example, it is difficult with the related-art data input apparatus to output candidates of conversion using the search character string as a key as described in the embodiment. Realistically, it would be difficult to maintain a candidate of conversion for each search character string arbitrarily input by the user.

Meanwhile, quite a number of people can now access information communication terminals and broadband communication networks are made available. Many people in the world originate information on their own so that diverse information is accumulated on the communication network as collected knowledge. We can access the collected knowledge using a search service or the like so as to obtain various information.

The data input apparatus according to the embodiment is not only provided with capabilities of conversion using a dictionary maintained locally but also uses a search service or the like to use collected knowledge on the communication network as if it is its own dictionary. In other words, the inventive apparatus is virtually provided with a dictionary with infinite capacity. The inventor believes that the data input apparatus represents a pioneer data input apparatus suitable for the coming Web 2.0 era.

The embodiment is intended to be illustrative only and it will be obvious to those skilled in the art that various modifications to constituting elements and processes could be developed and that such modifications are also within the scope of the present invention.

In the embodiment, the search conversion processing unit 20 is described as communicating with a search service or the like. Alternatively, the search conversion processing unit 20 may maintain a database inside. The database may maintain information on the history of past search conversion processes such as pairs of past search data and search result data and pairs of past search data and data ultimately selected by the user. When the user requests a search conversion process using the search data existent in the database again, the database may output the search result data or the previously selected data. With this, the frequency of accesses to a search service etc. is reduced and response to search conversion requests is improved.

What is claimed is:

1. A data input apparatus comprising:
an input acknowledging unit configured to acknowledge data from a user;
an ordinary conversion processing unit configured to output data generated by converting the input data acknowledged from the user;
a search conversion processing unit configured to output data generated from a result of search conducted based on the input data acknowledged from the user, wherein
the ordinary conversion processing unit comprises:
a candidate extracting unit configured to extract a candidate of converted data by referring to a dictionary database by using the input data; and
a candidate displaying unit configured to display the candidate of converted data and acknowledge the selection of converted data from the user, wherein
the search conversion processing unit comprises:
a communication unit configured to issue a search request to a search service by using the input data so as to obtain search result data; and
a search conversion displaying unit configured to display the search result data or a candidate of converted data obtained by processing the search result data in accordance with a predetermined condition.

2. The data input apparatus according to claim 1, wherein
the search conversion displaying unit displays a browser for displaying a search data input screen or search result data, and
the input acknowledging unit acknowledges at least one item of data arbitrarily designated by the user from the search result displayed in the browser.

3. The data input apparatus according to claim 2, further comprising:
a search conversion order determining unit configured to determine the order of arranging the search result data in accordance with the relevance to the context occurring before and after a position where data is output, wherein
the search conversion displaying unit displays the search result data in accordance with the order of arrangement determined by the search conversion order determining unit.

4. The data input apparatus according to claim 1, wherein
the communication unit uses path information to issue a directory search request to a directory management service and obtains lower path information as search result data,
the search conversion displaying unit displays the lower path information in a directory tree screen, and
the input acknowledging unit acknowledges path information arbitrarily designated by the user from the path information in the directory tree screen.

5. The data input apparatus according to claim 1, further comprising:
a search conversion candidate extracting unit configured to acknowledge search result data from the communication unit and extract a candidate of converted data from the search result data in accordance with a predetermined condition; and
a search conversion order determining unit configured to determine, when a plurality of candidates of converted data are extracted by the search conversion candidate extracting unit, the order of displaying the plurality of candidates of converted data in accordance with a predetermined condition, wherein
the search conversion displaying unit displays the candidates of converted data in accordance with the display order determined by the search conversion order displaying unit and acknowledges the selection of converted data from the user.

6. The data input apparatus according to claim 5, wherein
the search conversion candidate extracting unit extracts candidates of converted data from search result data in accordance with the relevance to the context occurring before and after a position where data is output, and
the search conversion order determining unit determines the order of arranging the candidates of converted data in accordance with the relevance to the context occurring before and after a position where data is output.

7. The data input apparatus according to claim 6, wherein
the communication unit issues a request for translation to a translation service so as to obtain a translation result, and
the search conversion candidate extracting unit extracts a candidate of converted data from the translation result in accordance with the relevance to the context occurring before and after a position where data is output.

8. The data input apparatus according to claim 5, wherein
the communication unit provides a search service with a request to search for a plurality of synonym data items so as to obtain search result data comprising the synonym data items, and
the search conversion candidate extracting unit extracts, as candidates of converted data from, the synonym data items from the search result data, and
the search conversion order determining unit determines the order of arranging the candidates of converted data in accordance with the number of hits of each synonym data item in the search result data.

9. The data input apparatus according to claim 5, wherein
the communication unit provides a search service with a request to search for at least one data item related to a mathematical expression so as to obtain search result data comprising the data related to a mathematical expression,
the search conversion candidate extracting unit extracts, as a candidate for converted data, the data related to a mathematical expression from the search result data, and
the search conversion order determining unit determines the order of arranging the candidates of converted data in accordance with the relevance to the context occurring before and after a position where data is output.

10. A data input method comprising:
acknowledging data from a user;
i) outputting data generated by converting the input data acknowledged from the user;
ii) outputting data generated from a result of search conducted based on the input data acknowledged from the user, wherein
step i) comprises:
extracting a candidate of converted data by referring to a dictionary database by using the input data; and
displaying the candidate of converted data and acknowledging the selection of converted data from the user, and
step ii) comprises:
issuing a search request to a search service by using the input data so as to obtain search result data; and
displaying the search result data or a candidate of converted data obtained by processing the search result data in accordance with a predetermined condition.

11. A program embedded in a recording medium, comprising:
a module configured to acknowledge data from a user;
an ordinary conversion module configured to output data generated by converting the input data acknowledged from the user;
a search conversion module configured to output data generated from a result of search conducted based on the input data acknowledged from the user, wherein
the ordinary conversion module comprises:
a module configured to extract a candidate of converted data by referring to a dictionary database by using the input data; and
a module configured to display the candidate of converted data and acknowledge the selection of converted data from the user, wherein
the search conversion module comprises:
a module configured to issue a search request to a search service by using the input data so as to obtain search result data; and
a module configured to display the search result data or a candidate of converted data obtained by processing the search result data in accordance with a predetermined condition.
